(19) United States
(12) Patent Application Publication
(10) Pub. No.: US 2008/0066319 A1
(43) Pub. Date: Mar. 20, 2008

(54) Replaceable Steel Chisel Structure

(76) Inventor: Hung-Ming Hu, Tainan Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/532,068

(22) Filed: Sep. 14, 2006

(51) Int. Cl. B25D 3/00

(52) U.S. Cl. 30/167

(57) ABSTRACT

A replaceable steel chisel structure includes a steel chisel, a sleeve, a cam ring, and a spring. The steel chisel is disposed with circular grooves. The sleeve is hollow to receive the steel chisel and disposed with channels to accommodate steel balls. The steel balls correspond in position to the circular grooves of the steel chisel. The cam ring is hollow to receive the sleeve and contains an eccentric chamber. The eccentric chamber is an increasingly larger arc space defined between the cam ring and the sleeve for the cam ring to hold against the steel balls and have the steel balls to be inserted into and hold against the circular grooves again.

### BACKGROUND OF THE INVENTION

(a) Field of the Invention

The present invention relates to a replaceable steel chisel structure, and more particularly, to one allowing fast change of a steel chisel by releasing steel balls in a sleeve with an eccentric chamber of a cam ring to free the steel balls from circular grooves of a steel chisel.

(b) Description of the Prior Art

Whereas a steel chisel is used to dig into hard materials including stone or concrete, frequent replacement is required during the work. Usually, the steel chisel is held in the existing manual operation mode; and the working surface is not necessarily level and smooth. The user could easily get cut or scratched without wearing a pair of gloves. A handle to cover up the shank of the steel chisel may help prevent injury, but it is not an economic option since the steel chisel gets worn out in short time.

### SUMMARY OF THE INVENTION

The primary purpose of the present invention is to provide a replaceable steel chisel structure to eliminate the problems related to the absence of a handle and cost concerns over cost with the handle.

To achieve the purpose, the present invention includes a steel chisel, a sleeve, a cam ring, a spring, and a handle. Wherein, the steel chisel is disposed with circular grooves. The sleeve is made hollow to receive insertion of the steel chisel and is provided with channels to contain steel balls. The steel balls correspond in position to the circular grooves of the steel chisel. The cam ring is also made hollow to receive insertion of the sleeve, and contains an eccentric chamber. The eccentric chamber is an increasingly larger arc space defined between the cam ring and the sleeve. The eccentric chamber corresponds to the steel balls of the sleeve upon rotating the cam ring. The cam ring is provided with a protruding pusher. The spring includes a first end and a second end opposite to each other. The first end is fixed to the cam ring and the second end is fixed to the handle for the cam ring to return and hold against the steel balls which are inserted against the circular grooves in the steel chisel.

The present invention allows fast replacement of a steel chisel by having the eccentric chamber in the cam ring to release the snap of the steel balls for them to clear out of the circular grooves in the steel chisel.

### BRIEF DESCRIPTION OF THE DRAWINGS

FIG. 1 is a perspective view of the present invention (with partially sectional view to disclose the combination profile).

FIG. 2 is a cross sectional view of the present invention (showing a schematic view of snap operation).

FIG. 3 is a schematic view showing the operation of releasing the snap for replacement of a steel chisel (cross sectional view).

### DETAILED DESCRIPTION OF THE PREFERRED EMBODIMENTS

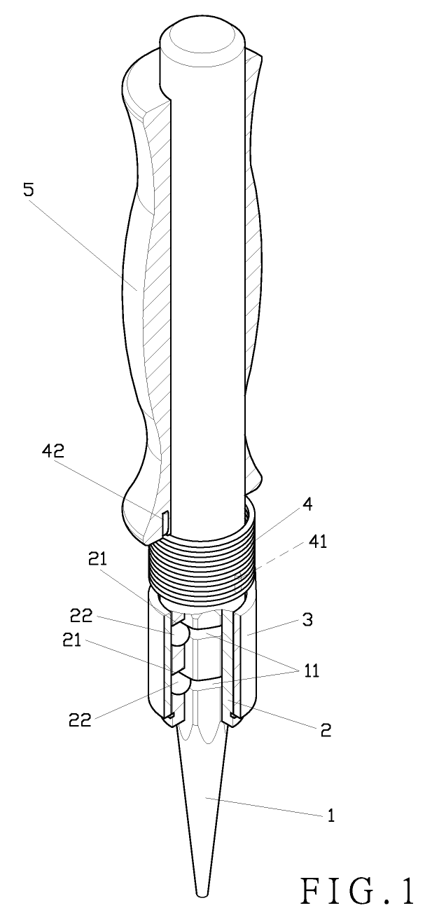

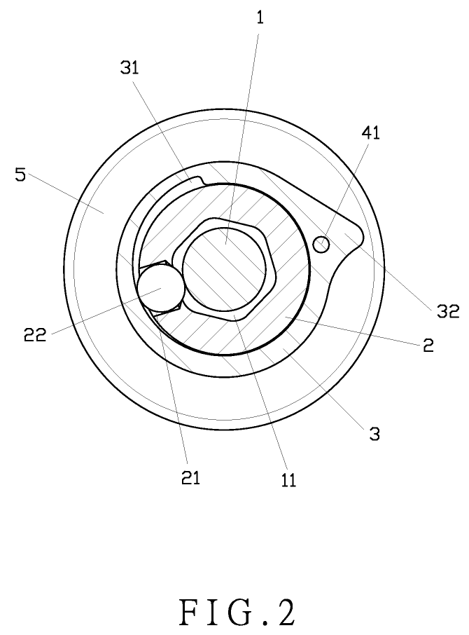

Referring to FIGS. 1 and 2, a preferred embodiment of the present invention comprises a steel chisel (1), a sleeve (2), a cam ring (3), a spring (4), and a handle (5).

The steel chisel (1) is disposed with circular grooves (11).

The sleeve (2) is made hollow to receive insertion of the steel chisel (1), and is provided with channels (21) to accommodate steel balls (22). The steel balls (22) correspond in position to the circular grooves (11) of the steel chisel (1).

The cam ring (3) is made hollow to receive insertion of the sleeve (2), and contains an eccentric chamber (31) defined by an increasingly larger arc space located between the cam ring (3) and the sleeve (2) so as to correspond to the relation between the eccentric chamber (31) and the steel balls (22) in the sleeve (2) upon rotating the cam ring (3). A pusher (32) protrudes from the cam ring (3) to facilitate applying the force to rotate the cam ring (3).

The spring (4) includes a first end (41) and a second end (42) opposite to each other. The first end (41) is fixed to the cam ring (3) and the second end (42) is fixed to the handle (5).

As illustrated in FIG. 2, the spring (4) returns the cam ring (3) to its original place and to hold against the steel balls (22). The steel balls (22) are then forced to move towards the inner side of the channels (21) of the sleeve (2) and inserted into the circular grooves (11) of the steel chisel (1), as illustrated in FIG. 1. The steel chisel (1) is then secured in place for a user to hold the handle (5).

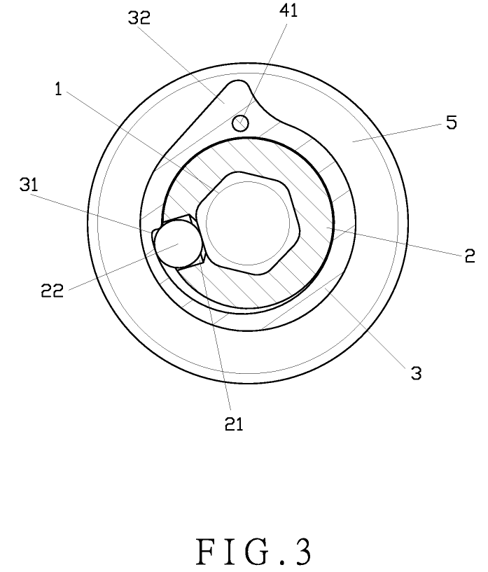

Upon replacing the steel chisel (1) as illustrated in FIG. 3, the pusher (32) of the cam ring (3) is pressed to rotate the cam ring (3) for the eccentric chamber (31) to correspond to the steel balls (22) of the sleeve (2); meanwhile, the steel chisel (1) is pulled down due to gravity for the circular grooves (11) of the steel chisel (1) to hold against and force the steel balls (22) to move from the inner side to the outer side of the channels (21) while a certain part of the steel balls (22) will enter into the eccentric chamber (31) and the used steel chisel (1) with the replacement moved in position. Releasing the pusher (32), the spring (4) returns the cam ring (3) to its original place for the cam ring (3) to hold against the steel balls (22) once again. The steel balls (22) are then inserted into and hold against the circular grooves (11) in the steel chisel (1) to secure a desired steel chisel (1) in place.

What is claimed is:

1. A replaceable steel chisel structure, comprising:
a steel chisel, the steel chisel being disposed with circular grooves;
a sleeve, the sleeve being made hollow to receive insertion of the steel chisel and disposed with channels to accommodate steel balls, the steel balls corresponding in position to the circular grooves of the steel chisel;
a cam ring, the cam ring being made hollow to receive insertion of the sleeve and disposed with an eccentric chamber corresponding to the steel balls of the sleeve upon rotating the cam ring; and
a spring, the spring being fixed to the cam ring to return the cam ring to its original place while having the cam ring to hold against the steel balls for the steel balls to be inserted into and hold against the circular grooves of the steel chisel.

2. The replaceable steel chisel structure as claimed in claim 1, wherein the eccentric chamber in the cam ring is formed by an increasingly larger arc space located between the cam ring and the sleeve.

3. The replaceable steel chisel structure as claimed in claim 1, further comprising a handle, the spring including a first end and a second end opposite to each other, the first end being fixed to the cam ring and the second end being fixed to the handle.

4. The replaceable steel chisel structure as claimed in claim 1, wherein the cam ring is provided with a protruding pusher.
